(19) United States
(12) Patent Application Publication
(10) Pub. No.: US 2014/0104818 A1
(43) Pub. Date: Apr. 17, 2014

(54) HYBRID PHOTOVOLTAIC LIGHT FIXTURE/TROFFER

(71) Applicants: Peymon Khojasteh, Towson, MD (US); Pedram Khojasteh, Towson, MD (US)

(72) Inventors: Peymon Khojasteh, Towson, MD (US); Pedram Khojasteh, Towson, MD (US)

(21) Appl. No.: 13/652,888

(22) Filed: Oct. 16, 2012

(51) Int. Cl. F21L 4/08

(52) U.S. Cl. CPC F21L 4/08
USPC 362/183; 362/190; 315/312

(57) ABSTRACT

The light troffer/fixture which contains photovoltaic sheets that reclaims the direct/ambient light/heat energy of the internal lamps/tubes of said troffer and converts it into useable energy, thereby powering additional tubes/lamps located either in the same fixture, or adjacent fixtures.

### CROSS REFERENCE TO RELATED APPLICATIONS

This application claims the benefit of U.S. Provisional Application No. 61/627,722 filed Oct. 18, 2011.

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM, LISTING COMPACT DISC APPENDIX

Not applicable

### BACKGROUND OF THE INVENTION

This invention relates to lighting fixtures and troffers commonly found in office buildings. Common light fixtures in offices utilize around 140 watts of energy, and are therefore a substantial drain on the power grid. It is possible to improve the energy consumption of these devices greatly, and reduce the amount needed to operate a well lit facility. The prior art uses solar panels that harness sunlight to power exterior street lamps; these items cannot and do not harness ambient light, which may be given from any light source, the prior art only uses direct sunlight and is used for exterior lighting only.

### BRIEF SUMMARY OF THE INVENTION

The invention is a troffer/fixture which contains a photovoltaic sheet or series of photovoltaic cells that reclaims the light/heat energy of the internal lamps/tubes and converts it into useable energy, thereby powering additional tubes/lamps located either in the same fixture, or adjacent fixtures.

### BRIEF DESCRIPTION OF THE SEVERAL VIEWS OF THE DRAWING

FIG. 1 is a front view of a photovoltaic cell powered troffer in accordance with the invention,

FIG. 2 is a bottom view of one embodiment of the troffer.

FIG. 3 is a perspective view of one embodiment of the troffer.

FIG. 4 is an exploded view of one embodiment of the troffer, showing how the various elements connect to form the device.

FIG. 5 is a bottom view of one embodiment of the troffer showing how the various elements are wired together.

### DETAILED DESCRIPTION OF THE INVENTION

The invention allows for a significant reduction in the energy usage of a given light fixture, and as many of these fixtures exist in a building, it can dramatically reduce the energy use of a building. The old technology related to this works with direct sunlight; often a series of solar panels are placed in a building's roof and the energy is used inside. Once the energy captured on the roof is used inside the building, it would have been “spent”. This technology will capture light energy inside each troffer, and use it to power adjacent tubes/lights, or even adjacent fixtures. This means that the energy a building uses is not simply spent, but recaptured and re-used, improving the energy efficiency of a building. The new technology can use photovoltaic cells that capture direct and ambient light, thereby re-using the light inside a building for further work; which is much more desirable both ecologically, and financially.

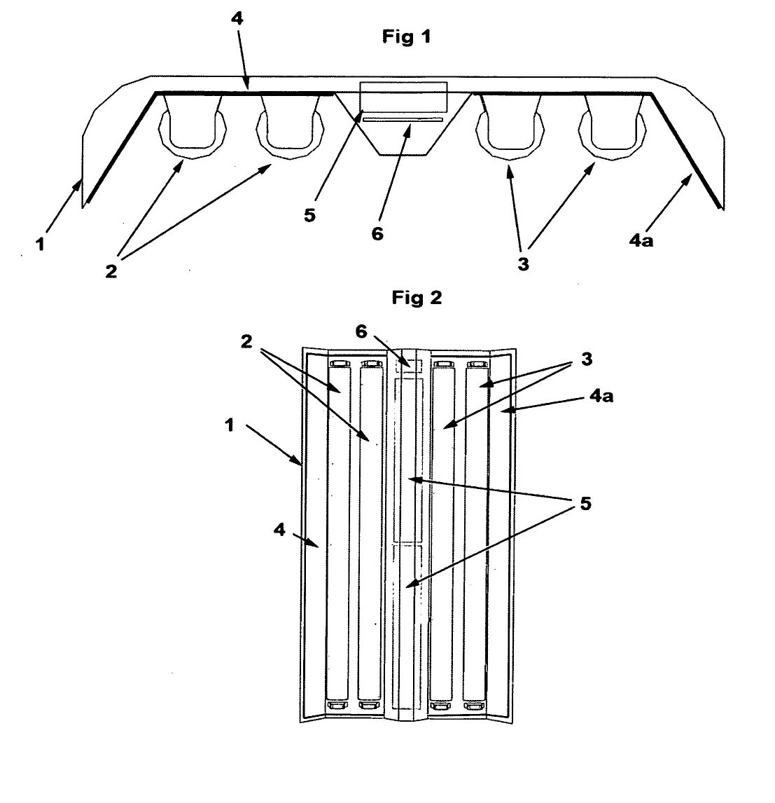

The light troffer/system consists of several critical elements, which combine to form a highly energy efficient light fixture. In order to recreate and build my invention, consider the following. In FIG. 1 a front view of a standard lighting Troffer 1 is available, you can purchase this item in a multitude of places. In one embodiment of the invention the left inside section of the Troffer 1 is lined with the Left photovoltaic sheet 4, and is in turn connected to the DC light tubes 3 by standard conductive wiring. The Right photovoltaic sheet 4a is connected to the Battery 5 and the Control module 6 by standard conductive wiring. The Battery 5 is connected to the Control Module 6, the AC light tubes 2, and the DC light tubes 3 by standard wiring in such a way as to provide power to them. The Control Module 6 is a microcontroller/microcomputer and also acts as a back-up power circuit, as referenced above in U.S. Pat. No. 619,217, and is connected to the Battery 5, the AC light tubes 2 and the DC light tubes 3.

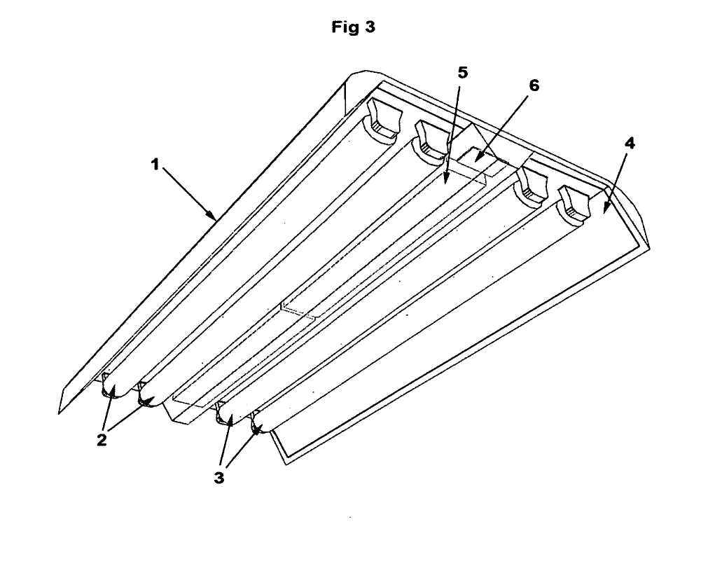

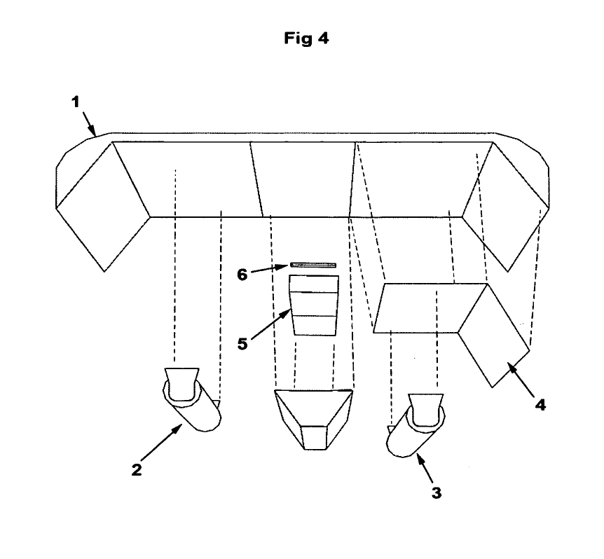

As seen in FIG. 2. In another embodiment of the invention, the DC light tubes 3 are connected to the Battery 5 and derive their power from that instead of the Left photovoltaic sheet 4. In this embodiment, the Left photovoltaic sheet 4 and the Right photovoltaic sheet 4a are connected to the Battery 5 and are always charging it. The Battery 5 may consist of any number of smaller power storage cells.

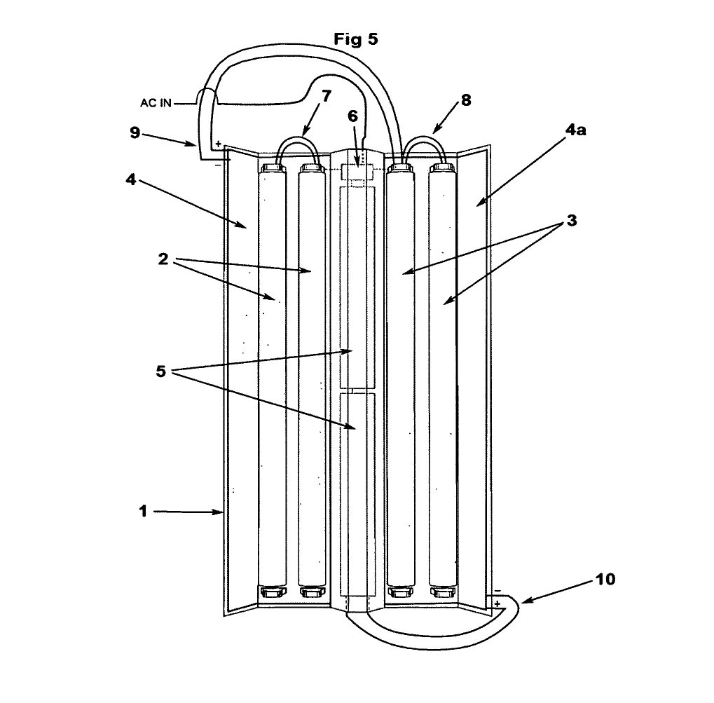

As seen in FIG. 5. a bottom view of the device along with the wiring outline. AC power from the grid connects directly to the Control module 6, which then routes the incoming power to the AC light tubes 2, which are connected to one another by the AC tube conductive wires 7, you can use copper or any other conductive wiring. The Left photovoltaic sheet 4 is connected to the DC light tubes 3 via the Left cell conductive wires 9. The DC light tubes are connected to one another via the DC tube conductive wires 8. The Right photovoltaic sheet 4a is connected to the Battery 5 via the Right cell conductive wires 10.

The above embodiments are not meant to be exhaustive, as the fixture can take many forms and use multiple forms of lighting technology such as LED lights, Induction lights, fluorescent lights, Halogen, incandescent, high/low pressure sodium, Mercury Vapor, Metal halide, or one of many others.

In operation, the troffer is installed the same way a standard troffer is installed today. The AC light tube 2 illuminates when a user turns on a light switch in a given room. This utilizes available AC power from the grid. The AC light tube 2 stimulates the Left photovoltaic sheet 4 which reclaims light energy and transfers it to the DC light tubes 3 through conductive wiring. When the DC light tube 3 illuminates it stimulates the Right photovoltaic sheet 4a and the reclaimed light energy is stored in the Battery 5.

In the event of a power outage, the Control module 6 activates and distributes energy to the DC Light tubes 3, thereby providing some light redundancy.

In another embodiment of the invention it operates as such: the AC light tube 2 illuminates when a user turns on a light switch in a given room. This utilizes available AC power from the grid. The AC light tube 2 stimulates the Left photovoltaic sheet 4 which reclaims light energy and transfers/stores it to Battery 5 through conductive wiring. The DC light tubes 3 turns on by using energy from the Battery 5, while the Right photovoltaic sheet 4a reclaims light energy and transfers/stores it to the Battery 5.

In the event of a power outage, the Control module 6 activates and distributes energy to the DC Light tubes 3, thereby providing some light redundancy.

The above methods of operation are not meant to be exhaustive, but merely suggestive of the multiple forms of operation possible via the plurality of embodiments.

Example: An example embodiment of this device could use two seventeen watt AC LED and two fifteen watt DC LED tubes , where the AC tubes are powered by 115 watts from the grid, and the DC LED tubes are powered by the energy reclaimed from the solar cells. Current solar cells in our tests have yielded between 40 to 68 watts at 12 volts. The DC tubes only need 30 watts at 12 volts to operate.

Some comparison calculations:

### EXAMPLE 1

F32/T8 Lights, currently available, are 32 watts per lamp, and require a 20 watt ELIG Ballast. Therefore a standard 4 lamp troffer with fluorescent lights uses 148 watts of energy.

4 Lamps×32 w=128 w+20 w ELIG=148 w per troffer/fixture

### EXAMPLE 2

AC LED Lights, Currently available, are 17 watts per lamp, and require no Ballast.

4 Lamps×17 w=68 w per troffer/fixture

### PROPOSED INVENTION

AC LED Lights, Currently available, 17 watts per lamp, and DC LED Lights, Currently available, are 15 watts per lamp, no Ballast. The AC LED's provide energy to the Photovoltaic cells, which in turn powers the DC LEDs.

(2 AC Lamps×17 w=34 w)+(2 DC Lamps×15 w=30 w−30 w from Photovoltaic cells)=34 w

### REFERENCE NUMERALS

1—Troffer
2—AC light tubes
3—DC light tubes
4—Left photovoltaic sheet
4a—Right photovoltaic sheet
5—Battery
6—Control module
7—AC tube conductive wires
8—DC tube conductive wires
9—Left cell conductive wires
10—Right cell conductive wires

We claim:

1. An energy reclamation light fixture comprising:
a. A troffer with lights.
b. Integrated photovoltaic cells which reclaim light energy from the lights in the troffer and deliver it to other lights or another part of the fixture or another fixture.

2. The energy reclamation light fixture from claim 1 further comprising a battery to store and distribute reclaimed energy.

3. The energy reclamation light fixture from claim 1 further comprising a control module/microcontroller that provides programmed functions.
